(19) United States
(12) Patent Application Publication
(10) Pub. No.: US 2002/0084976 A1
(43) Pub. Date: Jul. 4, 2002

(54) Ergonomic pointing device

(76) Inventor: Hao-Fong Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/851,584

(22) Filed: May 10, 2001

(30) Foreign Application Priority Data
Dec. 29, 2000 (TW) 089128204

(51) Int. Cl. G09G 5/00; G09G 5/08

(52) U.S. Cl. 345/156

(57) ABSTRACT

A pointing device includes a housing with a wrist protection pad for placement of a user's wrist while using the pointing device, a cursor directing device for generating displacement signals of a cursor, and a key device for generating key signals.

### BACKGROUND OF THE INVENTION

1. Field of the Invention

The present invention relates to a pointing device, and more particularly, to a pointing device that prevents injury to the fingers and wrist that can occur from long periods of use.

2. Description of the Prior Art

The GUI interface has become the mainstream of operating interfaces for operating systems because of its visual, lively, and user-friendly operating method. With these characteristics, pointing devices are also necessary to work in tandem with the GUI interface for controlling the movements of a cursor.

Considering the popularity of pointing devices, the time spent using these devices is increasing. Because of design flaws of many pointing devices, damage may be inflicted upon the fingers and wrists of a user after long periods of use. The repetitive and laborious nature of using a pointing device leads to a cumulative trauma disorder called Repetitive Strain Injury. Though the force for moving the pointing device is not very large, it is nonetheless sufficient to injure the user, similar to sports injuries, due to the extended periods of time spent using the pointing device. Accordingly, it is very important to provide a new kind of pointing device that can protect users from these types of injuries.

Please refer to FIG. 1 and FIG. 2. FIG. 1 is a schematic diagram of a mouse 10 according to the prior art. FIG. 2 is a schematic diagram of the mouse 10 while a user is using it. The user must use the mouse 10 with the palm directed downward, and the wrist touching the desk, effecting a fulcrum. This results in an incorrect posture that causes hand injury after long periods of use. The common disorders after using not only the mouse 10, but also a track ball or a touch pad, are stenosing tenosynovitis, or carpal tunnel syndrome, which do damage to the neural system and the muscles of the user.

### SUMMARY OF THE INVENTION

It is therefore an objective of the present invention to provide a pointing device with design characteristics that reduce the probability of injuring a user's hands and wrists.

In accordance with the claimed invention, the present invention pointing device includes a housing with a wrist protection pad for placement of a user's wrist while using the pointing device, a cursor directing device for generating displacement signals of a cursor, and a key device for generating key signals.

It is an advantage of the present invention that the pointing device of the present invention reduces the possibility of injury when the pointing device is used for long periods of time, as the wrist protection pad provides proper placement of the user's wrist during use.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a perspective view of a mouse according to the prior art.

FIG. 2 is a schematic diagram of using the mouse of FIG. 1.

FIG. 3 is a front view of a pointing device according to the present invention.

FIG. 4 is a side view of the pointing device of FIG. 3.

FIG. 5 is a top view of the pointing device of FIG. 4.

FIG. 6 is a front view of using the pointing device of FIG. 3.

FIG. 7 is a side view of using the pointing device of FIG. 3.

FIG. 8 is a top view of using the pointing device of FIG. 3.

FIG. 9 is a side view of another pointing device according to the present invention.

FIG. 10 is a top view of the pointing device of FIG. 9.

FIG. 11 is a side view of the third embodiment of the pointing device of the present invention.

FIG. 12 is a perspective view of the fourth embodiment of the pointing device according to the present invention.

FIG. 13 illustrates the pointing device in FIG. 12 being used.

FIG. 14 illustrates a fifth embodiment of the present invention in use.

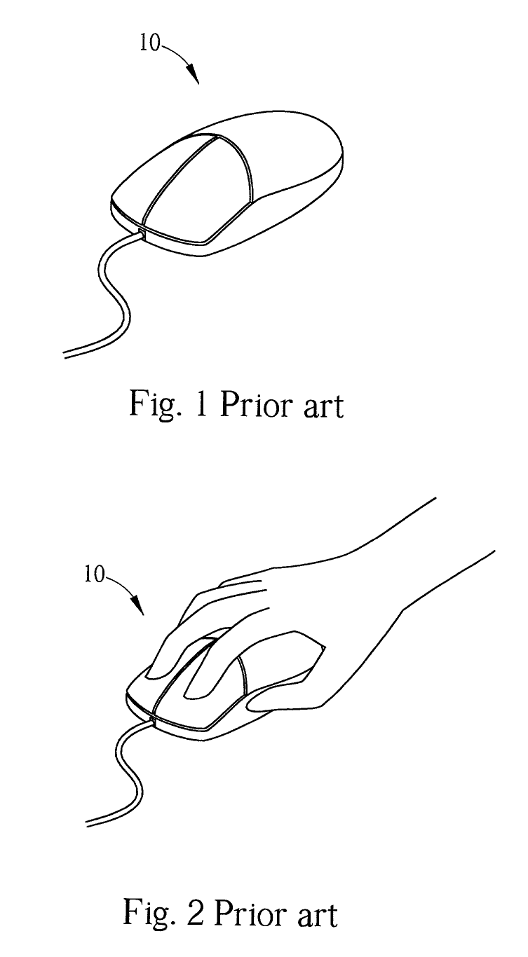

### DETAILED DESCRIPTION OF THE PREFERRED EMBODIMENT

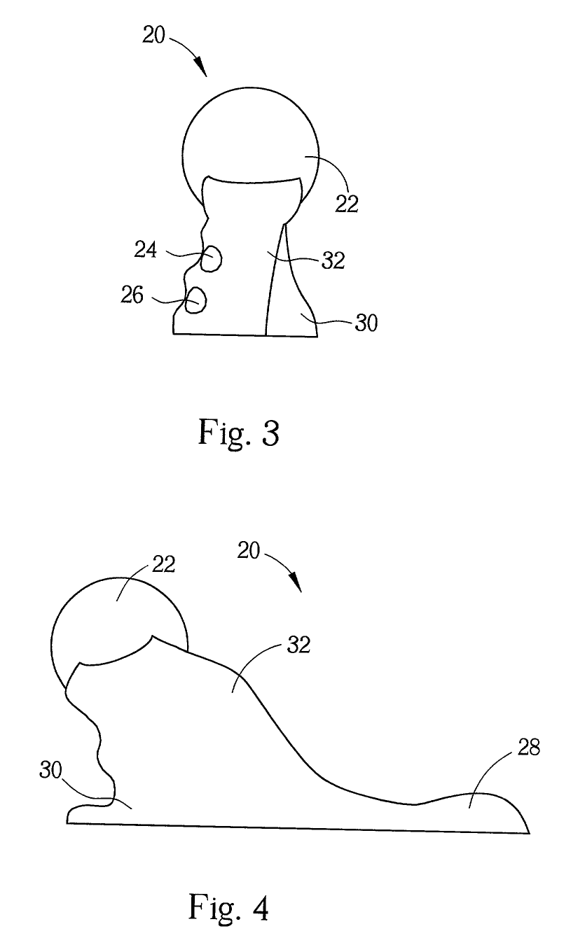

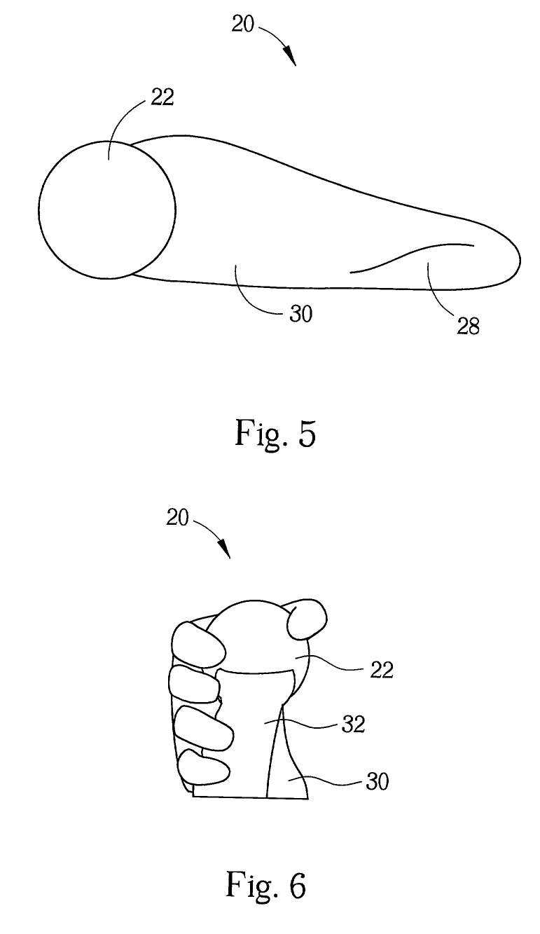

Please refer to FIG. 3 to FIG. 5. FIG. 3, FIG. 4 and FIG. 5 are a front view, a side view and a top view of a pointing device 20 according to the present invention, respectively. The embodiment shown of the present invention is designed for right-handed users. However, it should be obvious to one with ordinary skill in the art that the present invention could also be designed for left-handed users. The pointing device 20 includes a housing 30 and a handle 32 set nearly vertical to the housing 30. The handle 32 extends from the housing 30. A track ball 22 for generating displacement signals of a cursor is set upon the handle 32. The handle 32 is similar to an aviation controller used by pilots, in that the right front of the handle 32 includes two recesses for installing two key devices 24 and 26 for the placement of a user's index and middle fingers. The combination of displacement signals generated from the track ball 22 and key signals generated from the key devices 24 and 26 provide user-generated input from the pointing device 20. The left rear side of the housing 30 extends as a smooth bulge and forms a wrist protection pad 28.

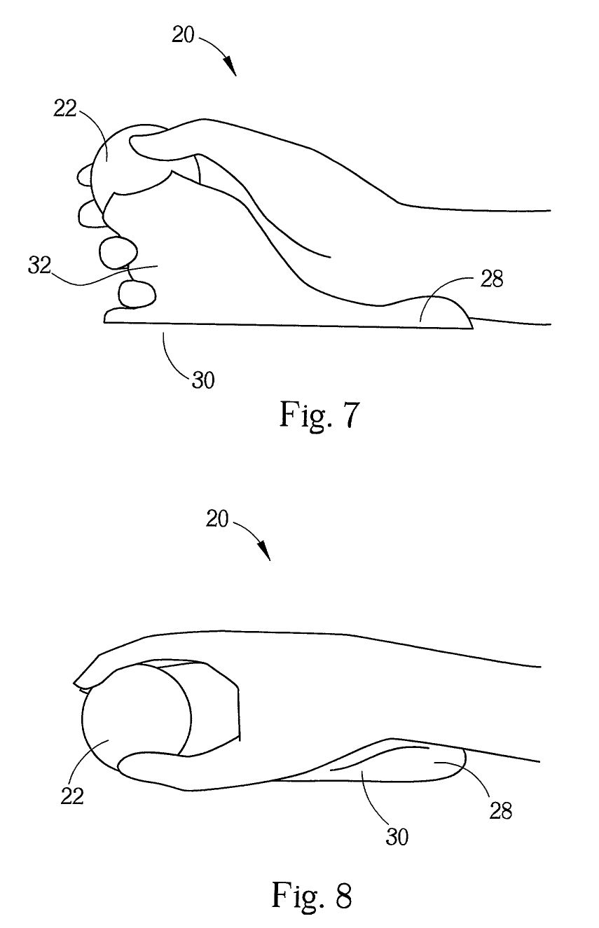

Please refer to FIG. 6 to FIG. 8.FIG. 6, FIG. 7, and FIG. 8 are a front view, a side view, and a top view, respectively, of the pointing device 20 being used. As shown in FIG. 6, the pointing device 20 enables the right hand of the user to lean leftward a bit, the key devices 24 and 26 being covered by the ring finger and the pinkie of the user. The track ball 22 can, thus, be controlled by the thumb, the index finger, and the middle finger of the user. And as shown in FIG. 7, the handle 32 is set nearly vertical to the housing 30, allowing the user's right palm to be vertical to the desk when using the pointing device 20. The user's wrist lies against the wrist protection pad 28, which provides placement of the user's wrist when using the pointing device 20.

Track balls according to the prior art are controlled with the user's palm directing downwardly, and that leads to cumulative damage to the user's fingers. In contrast with the prior art, the pointing device 20, according to the present invention, has the handle 32 for guiding the user to direct his palm leftward and control the track ball 22 using the thumb, the index finger, and the middle finger of his right hand.

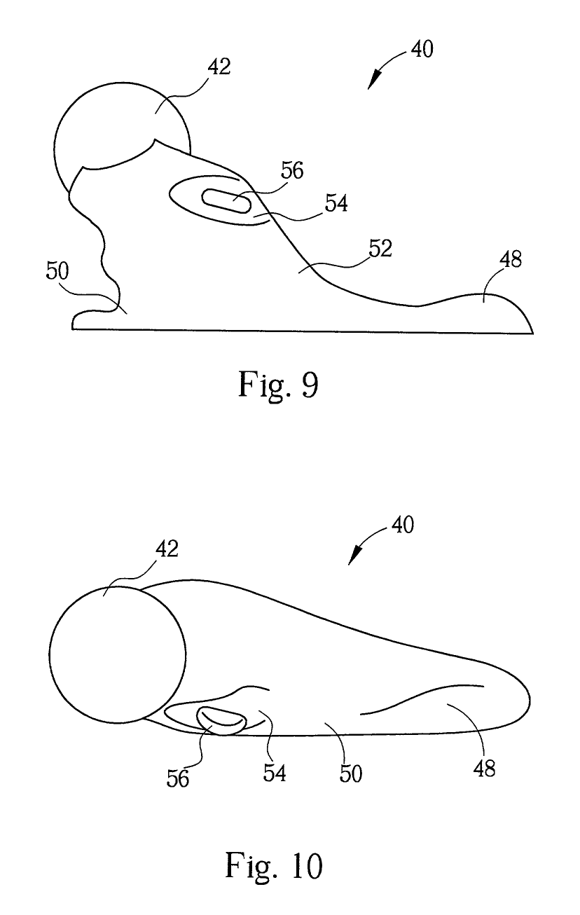

Please refer to FIG. 9 and FIG. 10. FIG. 9 and FIG. 10 are a side view and a top view, respectively, of another embodiment 40 according to the present invention. The pointing device 40 includes a housing 50 and a handle 52 set nearly vertical to the housing 50, which extends from the housing 50. The rear end of the housing 50 includes an extending wrist protection pad 48. The top end of the housing 50 has a track ball 42 as a cursor directing device, and the flank of the housing 50 has a recess 54, having a three-dimension roller 56, for the user's thumb. The three-dimension roller 56 is also used as a cursor directing device for controlling the positions of a cursor, and for scrolling a window of a GUI.

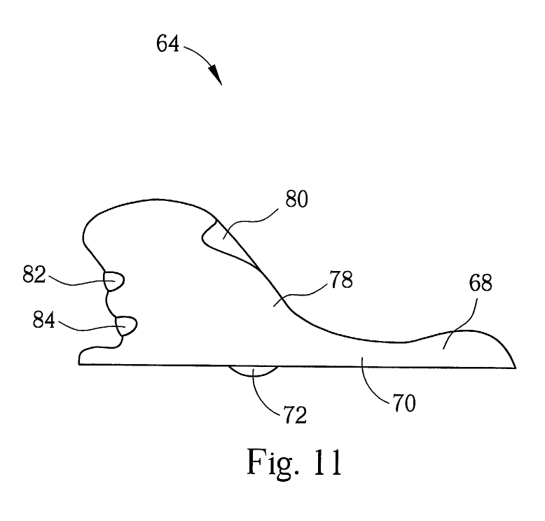

Please refer to FIG. 11. FIG. 11 is a side view of another embodiment 64 of the present invention. The pointing device 64 shown in FIG. 11 includes a housing 70 and a handle 78 set nearly vertical to the housing 70 and extending from the housing 70. The left side of the handle 78 has a recess 80, and enables the user to hold the handle 78 with the palm directing leftward. The recess 80 is for the user's thumb. The front end of the handle 78 has two key devices 82 and 84 for generating key signals, which are activated by the user's ring finger and pinkie. Similar to the previous embodiments, the housing 70 also includes a wrist protection pad 68 installed on the housing 70, and a cursor directing device 72 that can be rolled to generate displacement signals for a cursor. Because the cursor directing device 72 can be rolled, the pointing device 64 is similar to a mouse that can prevent the user from being injured after a long period of using the pointing device 64.

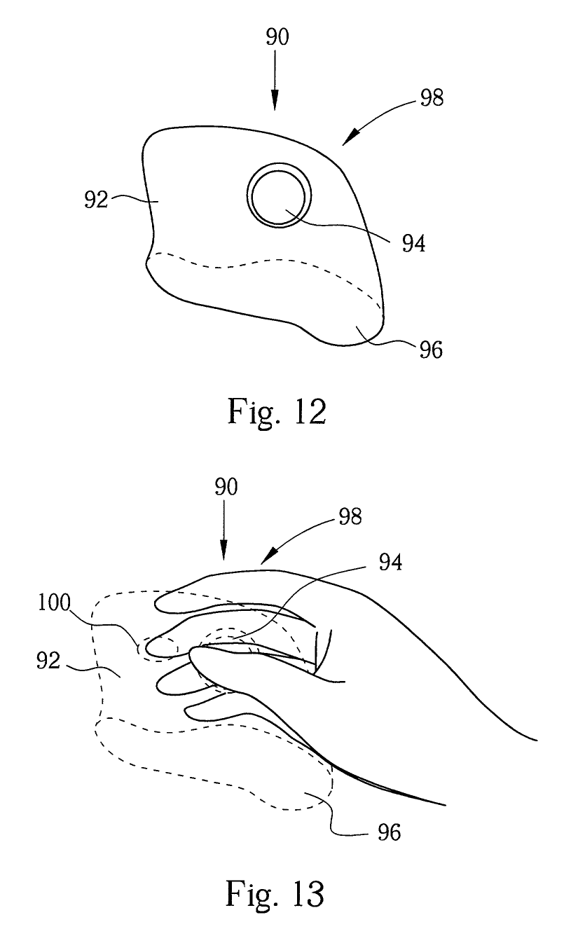

Please refer to FIG. 12 and FIG. 13. FIG. 12 is a schematic diagram of a fourth embodiment 90. FIG. 13 is a schematic diagram of using the pointing device 90. The pointing device 90 includes a standing housing 92 as its main body, and its bottom side 96 is placed upon a surface. The flank of the top side of the standing housing 92 includes a track ball 94 as a cursor directing device, and the other flank 98 of the top side, near to the user's palm, has a key device 100 for generating key signals. When using the pointing device 90, the standing housing 92 of the pointing device 90 guides the hand of the user, directing the palm leftward. Thus, the track ball 94 can be controlled by the thumb, which is stronger than the other fingers.

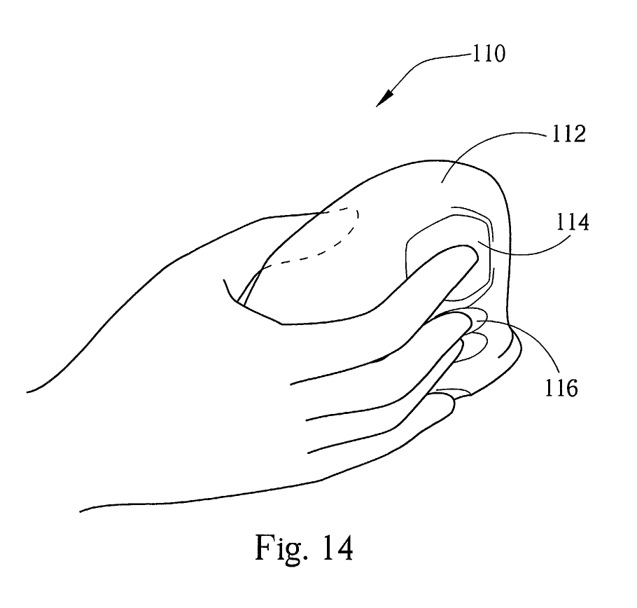

Please refer to FIG. 14. FIG. 14 illustrates the fifth pointing device 110 of the present invention in use. The pointing device 110 has a standing housing 112 as its main body, a touch pad 114 set on one side of the standing housing as a cursor directing device, and two key devices 116 to generate key signals. A user can easily control the touch pad 114 while remaining the palm leftward.

Though comfort and ease-of-use of pointing devices has become a common issue, the typical design characteristics of so-called ergonomic pointing devices focus on how to hold the pointing device with the wrist and fingers, and fails to address the fact that the force from the whole arm for moving the pointing device is most important from a standpoint of health. In contrast with the prior art, the pointing devices according to the present invention all have wrist protection pads for the placement of the user's wrist, guiding the user to use the pointing device with a more correct ergonomic posture. Furthermore, the location of the track ball according to the present invention enables the user to control the track ball in a more comfortable manner, similar to writing or holding an object.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A pointing device comprising:
a housing with a wrist protection pad for placement of a user's wrist while using the pointing device;
a cursor directing device for generating displacement signals of a cursor; and
a key device for generating key signals.

2. The pointing device of claim 1 further comprising a handle set nearly vertical to the housing, both the cursor directing device and the key device being located on the handle.

3. The pointing device of claim 2 wherein the cursor directing device is set on a top end of the handle.

4. The pointing device of claim 1 wherein the cursor directing device is a track ball.

5. The pointing device of claim 1 wherein the cursor directing device is a touch pad.

6. The pointing device of claim 1 wherein the cursor directing device is set on a bottom side of the housing.

7. A pointing device comprising:
a housing;
a handle set nearly vertical to the housing;
a cursor directing device for generating displacement signals of a cursor; and
a key device set on the handle for generating key signals.

8. The pointing device of claim 7 wherein the housing comprises a wrist protection pad for placement of a user's wrist while using the pointing device.

9. The pointing device of claim 7 wherein the cursor directing device is set on the top end of the housing.

10. The pointing device of claim 7 wherein the cursor directing device is a track ball.

11. The pointing device of claim 7 wherein the cursor directing device is a touch pad.

12. The pointing device of claim 7 wherein the cursor directing device is set on a bottom side of the housing.

13. A pointing device comprising:
a standing housing;
a cursor directing device set on the standing housing for generating displacement signals of a cursor; and
a key device set on the standing housing for generating key signals;
wherein the standing housing allows a user's palm to reset thereon vertically for operating the pointing device.

14. The pointing device of claim 13 wherein the cursor directing device is set at a location that corresponds to the user's thumb on the standing housing.

15. The pointing device of claim 13 wherein the cursor directing device is a track ball.
